(19) United States
(12) Patent Application Publication
(10) Pub. No.: US 2006/0258423 A1
(43) Pub. Date: Nov. 16, 2006

(54) Video poker game having cascading feature

(76) Inventors: Allon G. Englman, Chicago, IL (US); Peter A. Anderson, Chicago, IL (US); Paul A. McInerny, Chicago, IL (US); Matthew J. Ward, Northbrook, IL (US); Jeremy M. Hornik, Chicago, IL (US); Peter W. Flemming, Oak Park, IL (US); Daniel T. Murphy, Chicago, IL (US)

Correspondence Address: Daniel J. Burnham;JENKENS & GILCHRIST, A PROFESSIONAL CORPORATION, Ste. 2600, 225 W. Washington, Chicago, IL, 60606-3418, US

(21) Appl. No.: 11/407,107

(22) Filed: Apr. 18, 2006

Related U.S. Application Data
(60) Provisional application No. 60/672,295, filed on Apr. 18, 2005.

(51) Int. Cl. G06F 19/00

(52) U.S. Cl. 463/11

(57) ABSTRACT

A method of conducting a video poker game that includes a plurality of winning hands that award corresponding payouts to a player is disclosed. A wager is received from a player to play the video poker game and in response a final user-playable hand is formed. The final user-playable hand includes a plurality of cards that are displayed to the player on a display. In response to the final user-playable hand being one of the plurality of winning hands, the cards forming a winning combination within the winning hand are removed from the final user-playable hand and are replaced with other cards to form a first bonus hand. A first payout corresponding to the one of the plurality of winning hands in the final user-playable hand is awarded.

### CROSS REFERENCE TO RELATED APPLICATIONS

This application claims the benefit of priority of U.S. Provisional Patent Application No. 60/672,295, filed Apr. 18, 2005, which is hereby incorporated by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming machines, and methods for playing wagering games, and more particularly, to a gaming machine having a cascading feature within a video poker game.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

One concept that has been successfully employed to enhance the entertainment value of a game is the concept of a “secondary” or “bonus” game that may be played in conjunction with a “basic” game. The bonus game may comprise any type of game, either similar to or completely different from the basic game, which is entered upon the occurrence of a selected event or outcome in the basic game. Generally, bonus games provide a greater expectation of winning than the basic game and may also be accompanied with more attractive or unusual video displays and/or audio. Bonus games may additionally award players with “progressive jackpot” awards that are funded, at least in part, by a percentage of coin-in from the gaming machine or a plurality of participating gaming machines. Because the bonus game concept offers tremendous advantages in player appeal and excitement relative to other known games, and because such games are attractive to both players and operators, there is a continuing need to develop gaming machines with new types of bonus games to satisfy the demands of players and operators.

While bonus game features provide some enhanced excitement relative to other known games, there is a continuing need to develop new games that generate excitement within a video poker game.

### SUMMARY OF THE INVENTION

According to one aspect of the present invention, a method of conducting a wagering game on a gaming machine is disclosed. The method comprises receiving a wager from a player to play the game and displaying a plurality of cards from a deck of cards to form a user-playable hand. The method further comprises selecting, via player selection, one or more of the plurality of cards to discard and replacing each of the discarded cards with another card to form a final user-playable hand. The method further comprises initiating a cascade event in response to the final user-playable hand resulting in a winning hand being formed. The cascade event includes (i) removing winning cards from the winning hand of the final user-playable hand, and (ii) replacing the removed winning cards with other cards to form a first cascade hand.

According to another aspect of the present invention, a method of conducting a video poker game that includes a plurality of winning hands that award corresponding payouts to a player is disclosed. The method comprises receiving a wager from a player to play the video poker game and in response forms a final user-playable hand including a plurality of cards that are displayed to the player on a display. In response to the final user-playable hand being one of the plurality of winning hands, the cards forming a winning combination within the winning hand are removed from the final user-playable hand and are replaced with other cards to form a first bonus hand. A first payout corresponding to the one of the plurality of winning hands in the final user-playable hand is awarded.

According to yet another aspect of the invention, a computer readable storage medium is encoded with instructions for directing a gaming device to perform the above methods.

According to yet another aspect of the invention, a gaming machine for playing a wagering game is disclosed. The gaming machine comprises at least one display, an input device, and a controller. The at least one display displays a plurality of randomly selected cards distributed from a deck of cards. The plurality of cards forms a user-playable hand. One or more of the cards in the user-playable hand is selectable by a player to be held. Each of the non-selected cards is replaced by a card from the deck of cards. The held cards and the replacement cards form a final user-playable hand that indicates an outcome from a plurality of outcomes. At least one of the plurality of outcomes is a cascade-event-triggering outcome. The at least one display displays a cascade event in response to the outcome being the cascade-event-triggering outcome. The cascade event results in at least one cascade hand being formed subsequent to the final user-playable hand. The input device receives selections from the player as to which of the plurality of cards in the user-playable hand should be held. The controller is coupled to the display and the input device. The controller is operative to conduct the wagering game and the cascade event in response to receiving inputs from the input device. The controller is further operative to provide an award to the player based on the outcome of the wagering game and the cascade event.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a gaming machine embodying the present invention;

FIG. 2 is a block diagram of a control system suitable for operating the gaming machine;

FIG. 3 is an image of a main video-poker game screen that is displayed on the gaming machine of FIG. 1, according to one embodiment of the present invention.

FIG. 4 is an image of the main video-poker game screen of FIG. 3 including a winning-hands area.

FIG. 5 is an image of the main video-poker game screen of FIG. 4 with the cards from the winning hand being transferred to the winning-hands area.

FIG. 6 is an image of the main video-poker game screen of FIG. 5 after a first cascade hand has been formed.

FIG. 7 is an image of the main video-poker game screen of FIG. 6 after the winning cards from the first cascade hand have been transferred to the winning-hands area and a second cascade hand has been formed.

FIG. 8 is an image of a main video-poker game screen that is displayed on the gaming machine of FIG. 1, according to another embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

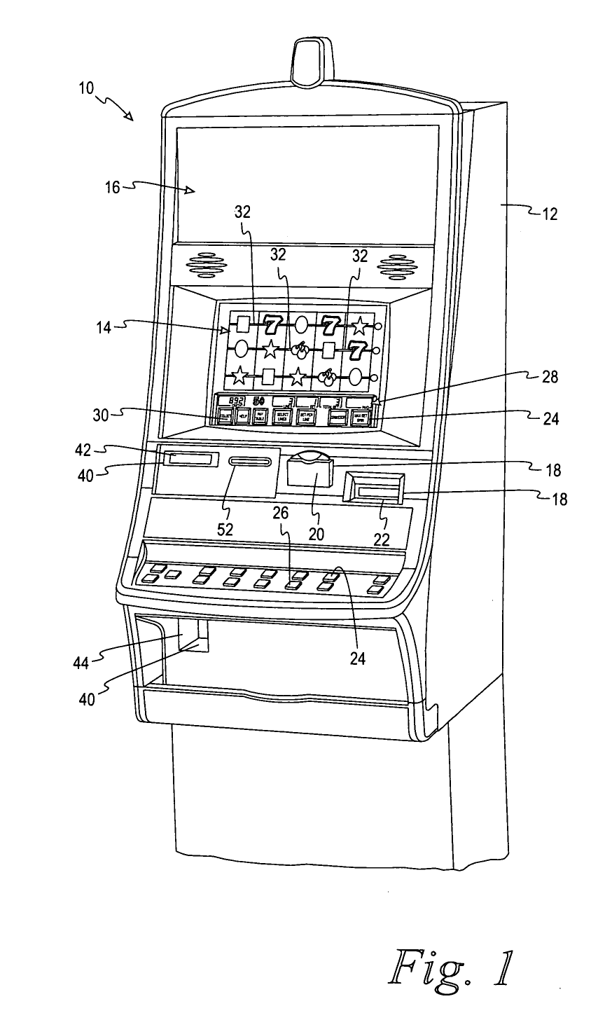

Referring to FIG. 1, a gaming machine 10 is used in gaming establishments such as casinos. With regard to the present invention, the gaming machine 10 may be any type of gaming machine and may have varying structures and methods of operation. For example, the gaming machine 10 may be an electromechanical gaming machine configured to play mechanical slots, or it may be an electronic gaming machine configured to play a video casino game, such as poker.

The gaming machine 10 comprises a housing 12 and includes input devices, including a value input device 18 and a player input device 24. For output the gaming machine 10 includes a primary display 14 for displaying information about the basic wagering game. The primary display 14 can also display information about a bonus wagering game and a progressive wagering game. The gaming machine 10 may also include a secondary display 16 for displaying game events, game outcomes, and/or signage information. While these typical components found in the gaming machine 10 are described below, it should be understood that numerous other elements may exist and may be used in any number of combinations to create various forms of a gaming machine 10.

The value input device 18 may be provided in many forms, individually or in combination, and is preferably located on the front of the housing 12. The value input device 18 receives currency and/or credits that are inserted by a player. The value input device 18 may include a coin acceptor 20 for receiving coin currency (see FIG. 1). Alternatively, or in addition, the value input device 18 may include a bill acceptor 22 for receiving paper currency. Furthermore, the value input device 18 may include a ticket reader, or barcode scanner, for reading information stored on a credit ticket, a card, or other tangible portable credit storage device. The credit ticket or card may also authorize access to a central account, which can transfer money to the gaming machine 10.

The player input device 24 comprises a plurality of push buttons 26 on a button panel for operating the gaming machine 10. In addition, or alternatively, the player input device 24 may comprise a touch screen 28 mounted by adhesive, tape, or the like over the primary display 14 and/or secondary display 16. The touch screen 28 contains soft touch keys 30 denoted by graphics on the underlying primary display 14 and used to operate the gaming machine 10. The touch screen 28 provides players with an alternative method of input. A player enables a desired function either by touching the touch screen 28 at an appropriate touch key 30 or by pressing an appropriate push button 26 on the button panel. The touch keys 30 may be used to implement the same functions as push buttons 26. Alternatively, the push buttons 26 may provide inputs for one aspect of the operating the game, while the touch keys 30 may allow for input needed for another aspect of the game.

The various components of the gaming machine 10 may be connected directly to, or contained within, the housing 12, as seen in FIG. 1, or may be located outboard of the housing 12 and connected to the housing 12 via a variety of different wired or wireless connection methods. Thus, the gaming machine 10 comprises these components whether housed in the housing 12, or outboard of the housing 12 and connected remotely.

The operation of the basic wagering game is displayed to the player on the primary display 14. The primary display 14 can also display the bonus game associated with the basic wagering game. The primary display 14 may take the form of a cathode ray tube (CRT), a high resolution liquid crystal display (LCD), a plasma display, an LED, or any other type of display suitable for use in the gaming machine 10. As shown, the primary display 14 includes the touch screen 28 overlaying the entire monitor (or a portion thereof) to allow players to make game-related selections. Alternatively, the primary display 14 of the gaming machine 10 may include a number of playing cards that are used to visually display a particular game outcome. In the illustrated embodiment, the gaming machine 10 is an “upright” version in which the primary display 14 is oriented vertically relative to the player. Alternatively, the gaming machine may be a “slant-top” version in which the primary display 14 is slanted at about a thirty-degree angle toward the player of the gaming machine 10.

A player begins play of the basic wagering game by making a wager via the value input device 18 of the gaming machine 10. A player can select play by using the player input device 24, via the buttons 26 or the touch screen keys 30. The basic game consists of a plurality of playing cards arranged to form poker hands that indicate one or more outcomes of the basic game. Such outcomes are randomly selected in response to the wagering input by the player. At least one of the plurality of randomly-selected outcomes may be a start-bonus outcome, which can include any variations of symbols or symbol combinations triggering a bonus game.

In some embodiments, the gaming machine 10 may also include a player information reader 52 that allows for identification of a player by reading a card with information indicating his or her true identity. The player information reader 52 is shown in FIG. 1 as a card reader, but may take on many forms including a ticket reader, bar code scanner, RFID transceiver or computer readable storage medium interface. Currently, identification is generally used by casinos for rewarding certain players with complimentary services or special offers. For example, a player may be enrolled in the gaming establishment's loyalty club and may be awarded certain complimentary services as that player collects points in his or her player-tracking account. The player inserts his or her card into the player information reader 52, which allows the casino's computers to register that player's wagering at the gaming machine 10. The gaming machine 10 may use the secondary display 16 or other dedicated player-tracking display for providing the player with information about his or her account or other player-specific information. Also, in some embodiments, the information reader 52 may be used to restore game assets that the player achieved and saved during a previous game session.

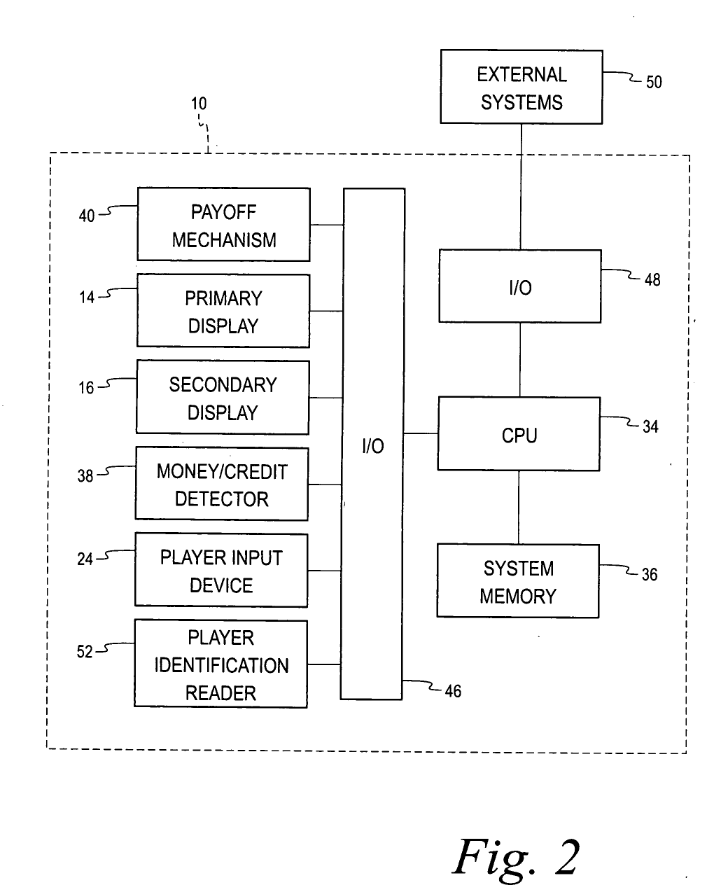

Turning now to FIG. 2, the various components of the gaming machine 10 are controlled by a central processing unit (CPU) 34, also referred to herein as a controller or processor (such as a microcontroller or microprocessor). To provide gaming functions, the controller 34 executes one or more game programs stored in a computer readable storage medium, in the form of memory 36. The controller 34 performs the random selection (using a random number generator (RNG)) of an outcome from the plurality of possible outcomes of the wagering game. Alternatively, the random event may be determined at a remote controller. The remote controller may use either an RNG or pooling scheme for its central determination of a game outcome. It should be appreciated that the controller 34 may include one or more microprocessors, including but not limited to a master processor, a slave processor, and a secondary or parallel processor.

The controller 34 is also coupled to the system memory 36 and a money/credit detector 38. The system memory 36 may comprise a volatile memory (e.g., a random-access memory (RAM)) and a non-volatile memory (e.g., an EEPROM). The system memory 36 may include multiple RAM and multiple program memories. The money/credit detector 38 signals the processor that money and/or credits have been input via the value input device 18. Preferably, these components are located within the housing 12 of the gaming machine 10. However, as explained above, these components may be located outboard of the housing 12 and connected to the remainder of the components of the gaming machine 10 via a variety of different wired or wireless connection methods.

As seen in FIG. 2, the controller 34 is also connected to, and controls, the primary display 14, the player input device 24, and a payoff mechanism 40. The payoff mechanism 40 is operable in response to instructions from the controller 34 to award a payoff to the player in response to certain winning outcomes that might occur in the basic game or the bonus game(s). The payoff may be provided in the form of points, bills, tickets, coupons, cards, etc. For example, in FIG. 1, the payoff mechanism 40 includes both a ticket printer 42 and a coin outlet 44. However, any of a variety of payoff mechanisms 40 well known in the art may be implemented, including cards, coins, tickets, smartcards, cash, etc. The payoff amounts distributed by the payoff mechanism 40 are determined by one or more pay tables stored in the system memory 36.

Communications between the controller 34 and both the peripheral components of the gaming machine 10 and external systems 50 occur through input/output (I/O) circuits 46, 48. More specifically, the controller 34 controls and receives inputs from the peripheral components of the gaming machine 10 through the input/output circuits 46. Further, the controller 34 communicates with the external systems 50 via the I/O circuits 48 and a communication path (e.g., serial, parallel, IR, RC, 10bT, etc.). The external systems 50 may include a gaming network, other gaming machines, a gaming server, communications hardware, or a variety of other interfaced systems or components. Although the I/O circuits 46, 48 may be shown as a single block, it should be appreciated that each of the I/O circuits 46, 48 may include a number of different types of I/O circuits.

Controller 34, as used herein, comprises any combination of hardware, software, and/or firmware that may be disposed or resident inside and/or outside of the gaming machine 10 that may communicate with and/or control the transfer of data between the gaming machine 10 and a bus, another computer, processor, or device and/or a service and/or a network. The controller 34 may comprise one or more controllers or processors. In FIG. 2, the controller 34 in the gaming machine 10 is depicted as comprising a CPU, but the controller 34 may alternatively comprise a CPU in combination with other components, such as the I/O circuits 46, 48 and the system memory 36.

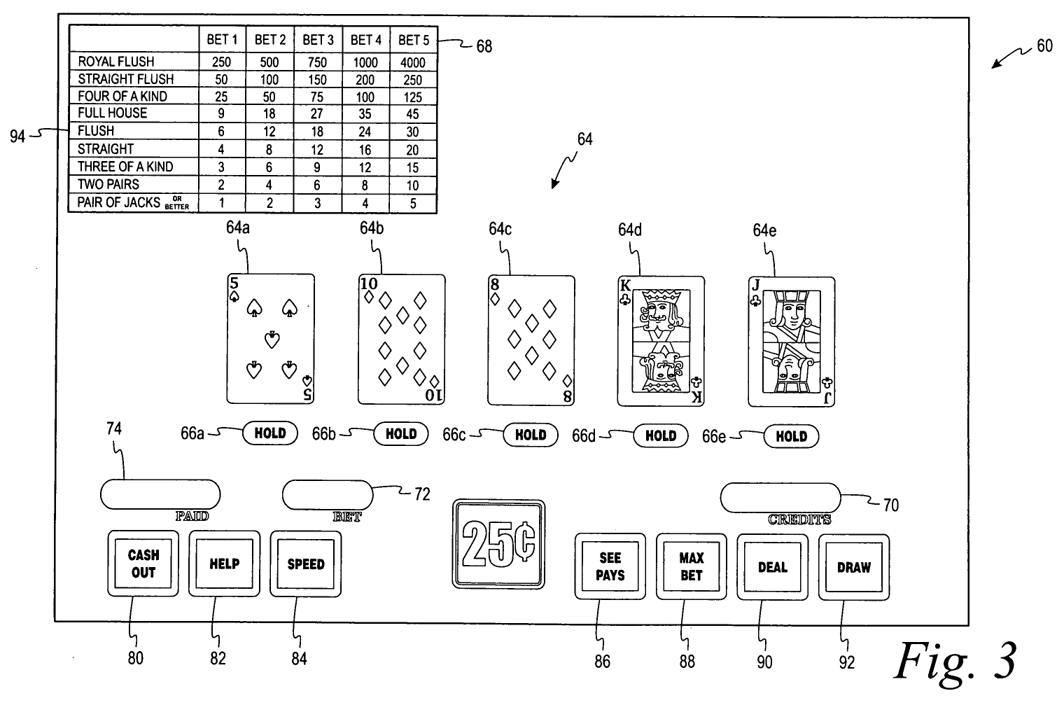

Turning now to FIG. 3, an image of a main video-poker game screen 60 is adapted to be displayed on the main video display 26 (FIG. 1). A player begins play of the basic wagering game by inserting a wager input into the value input device 18 of the gaming machine 10. A player can select play by either using the touch screen 28 or push buttons 26. The CPU 34, or the external systems 50 in alternative embodiments, operates to execute a wagering game program causing the primary display 14 to display the main video-poker game screen 60 that includes a plurality of visual elements.

According to one embodiment, a video poker game is played with a single, standard 52-card deck (i.e., Ace through King of four different suits). The standard 52-card deck may be supplemented with additional bonus cards such as value cards, wild card, etc. However, the video poker game may be played with any number of decks and/or with a variety of different card compositions.

According to one embodiment, during a particular poker hand, all of the cards are dealt from the same deck. After a card is dealt from the deck into the poker hand, the card is “used up” and cannot appear again until the next poker hand. The deck may be replenished and randomly shuffled prior to every poker hand. The memory 36 includes a data structure for storing data representing each card of the deck. The CPU 34 randomly selects cards for each poker hand from the data structure and controls the primary display 14 to display the cards.

An image of a main video-poker game screen can be seen in FIG. 3. The main video-poker game screen 60 featuring a five-card draw poker game in the illustrated embodiment is displayed on the primary display 14. The main video-poker game screen 60 is used to display a user-playable hand 64 composed of a plurality of cards 64a-e. According to one embodiment, each of the plurality of cards 64a-e has an associated hold button 66a-e, respectively. In the illustrated embodiment, the hold buttons 66a-e are located beneath their associated plurality of cards 64a-e on the main video-poker game screen 60. The hold buttons 66a-e may be a soft touch key 30 on the touch screen 28 and/or a push button 26. The main video-poker game screen 60 also displays a pay table 68, game session meters, and various buttons selectable by a player.

The game session meters include: a “credits” meter 70 for displaying a number of credits available for play on the machine; a “bet” meter 72 for displaying a number of credits wagered (e.g., from 1 to 5 credits); and a “paid” meter 74 for displaying an amount to be awarded based on the results of the particular rounds outcome. The player-selectable buttons include a “cash out” button 80 to collect the credits remaining in the credits meter 70; a “help” button 82 for viewing instructions on how to play the video poker game; a “speed” button 84 for allowing a player to adjust the speed that the cards are dealt, the hands are formed, the length of time the winning hand is displayed, the length of time the winnings are displayed, the overall speed of the game, etc.; a “see pays” button 86 for displaying a larger pay table to the player (or displaying the pay table in embodiments where the pay table is not constantly displayed); a “max bet” button 88 for wagering a maximum number of credits (e.g., 5 credits); a “deal” button 90 for causing the game to initially deal cards from a deck into the user-playable hand 64 face-up; and a “draw” button 92 for causing the game to replace any non-held card in the user-playable hand 64 with another card from the deck.

The pay table 68, shown on the primary display 14, may also or alternatively be displayed on the secondary display 16. The pay table 68 includes a list of winning poker-hand rankings 94 and a plurality of payout columns with payouts associated with each ranking. According to one embodiment, the number of credits won is linearly proportional to the number of credits wagered, except that a royal flush typically yields a bonus when achieved on a maximum wager. The list of winning poker hand rankings 94, as illustrated, includes standard poker-hand rankings beginning at a pair of jacks or better and includes hands through a royal flush.

To begin the wagering game, a player wagers one or more credits on the gaming machine 10. As illustrated in the pay table 68, a maximum wager for a standard wagering game is five credits, though the maximum wager may be any number of credits. Once a player wagers one or more credit, the terminal initiates the wagering game for the player. In the illustrated example, the player has decided to wager five credits.

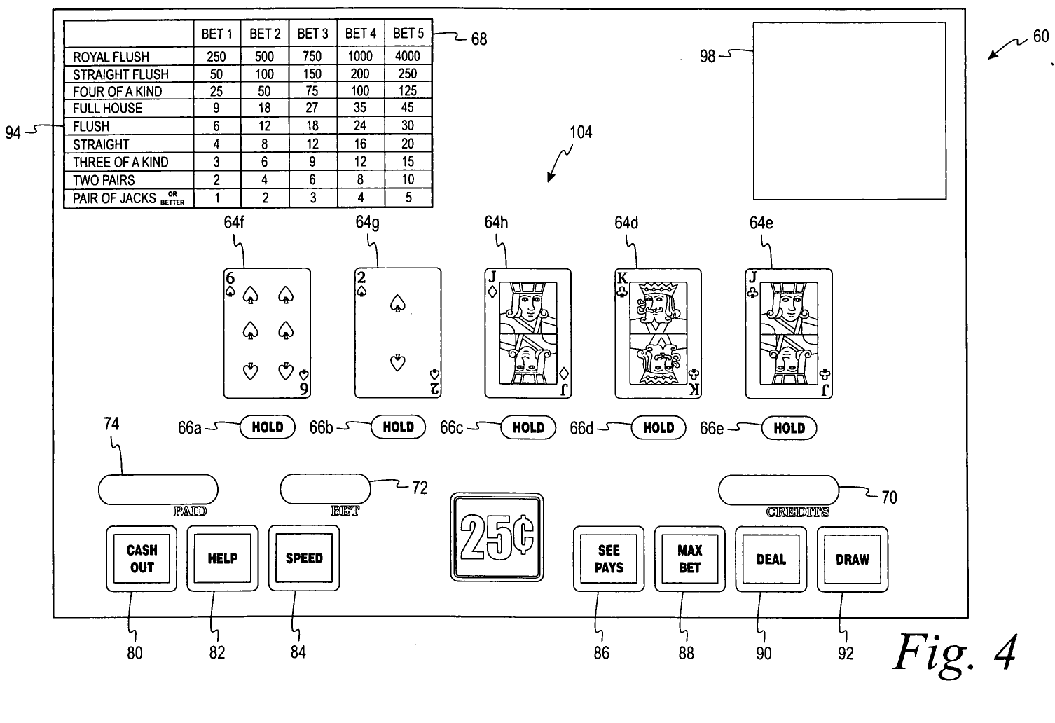

According to one embodiment, the poker game is five-card draw poker. In a five-card draw poker game, five cards 64a-e are displayed face-up to a player to form a user-playable hand 64. The player is able to select none, one, or a plurality of the cards 64a-e in the user-playable hand 64 to discard. Once a card has been selected to be discarded, any selected card is then replaced to form a final user-playable hand 104 (FIG. 4).

Referring also to FIG. 4, a player may decide to hold cards 64d and 64e, and can then hold the desired cards 64d,e by selecting the corresponding hold buttons 66d and 66e, respectively. Once the player has selected which of the plurality of cards 64a-e they desire to hold, the player selects the draw button 92. In alternative embodiments, the player has a predetermined time to select the cards they desire to hold, after which time, the gaming terminal 10 automatically initiates the draw. In these embodiments, the player may initiate a draw sooner by selecting the draw button 92 or may extend their time to decide by selecting an appropriate soft touch key 30 on the touch screen 28 or a designated push button 26. As illustrated in FIG. 4, the originally dealt cards 64a-c have been replaced by cards 64f-h to form the final user-playable hand 104. As illustrated, the final user-playable hand 104 matches one of the winning hands contained in the paytable 68 (i.e., a pair of Jacks).

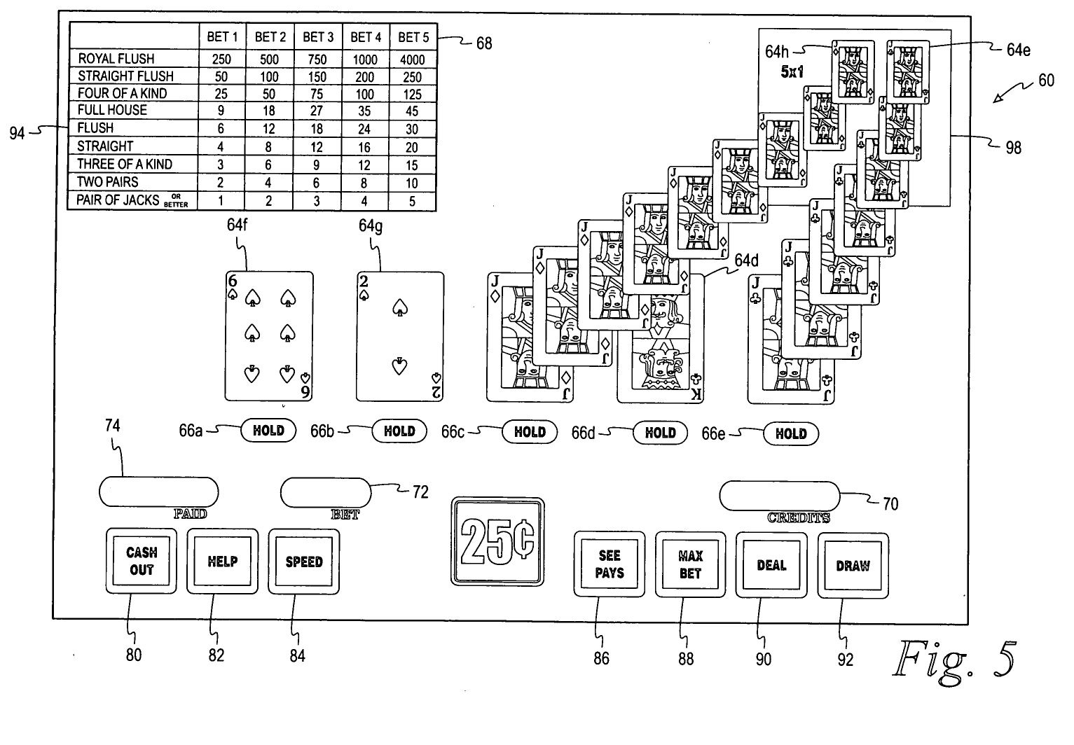

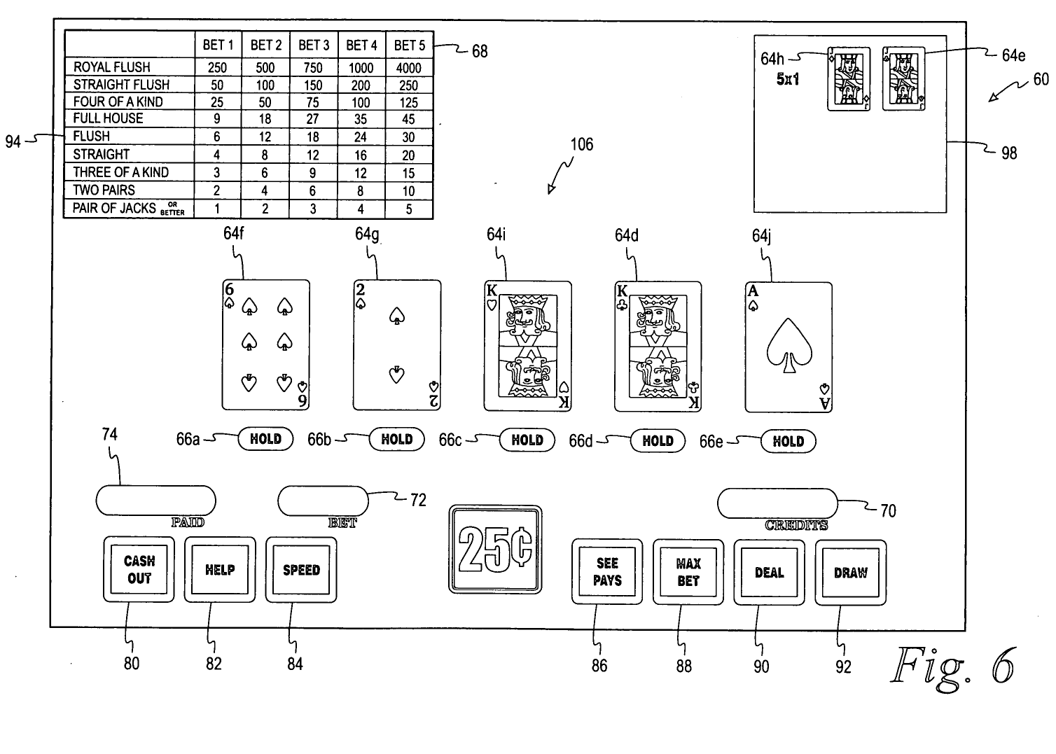

When a player has obtained a winning hand, an award value for the winning hand is awarded to the player. Furthermore, a cascading bonus event is initiated and the player has the opportunity to form additional winning hands on which a payout may be earned. No player input is required during the cascading bonus event. To begin the cascading bonus event, the winning cards 64h and 64e are moved to a winning-hands area 98, as shown by the embodiment illustrated in FIG. 5. The cards 64h and 64e that formed the winning hand are then replaced by cascading cards 64i and 64j, respectively. This “cascade” of cards in FIGS. 5-6 forms a first cascade hand 106. By replacing the winning cards with additional cards the player is provided with a bonus hand that may result in an additional winning hand. In the illustrated embodiment, the first cascade hand 106 matches one of the winning hands contained in the paytable 68 (i.e., a pair of kings). The second set of winning cards 64i and 64d are then moved to the winning-hands area 98, as was described above. The second set of winning cards 64i and 64d accompany the first set of winning cards 64h and 64e. In one embodiment for awarding a payout, once the second set of winning cards 64i and 64d are moved to the winning-hands area 98, the award value for the first set of winning cards 64h and 64e is awarded again to the player. Thus, with every additional winning cascade hand, the player re-earns the award value from the prior wins, as well as the award value for the current winning cascade hand.

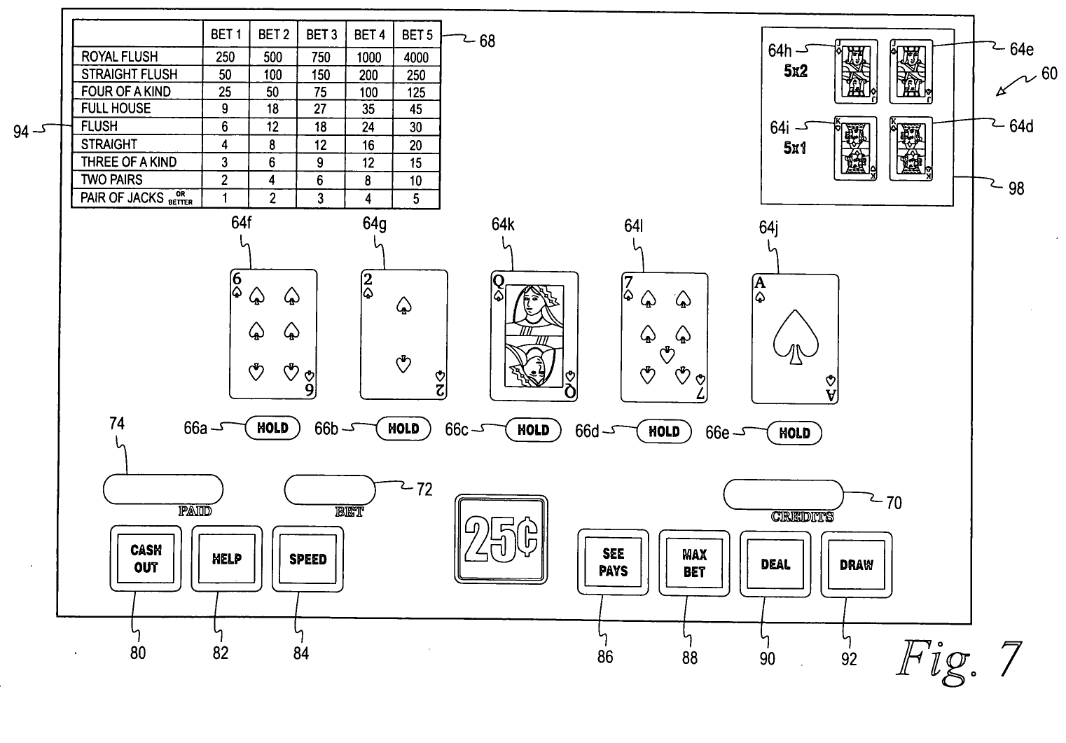

Referring also to FIG. 7, after the second set of winning cards 64i and 64d (FIG. 6) have been removed, they are replaced with cascading cards 64k and 641. As illustrated, the cascading cards 64k and 641, in combination with the non-winning cards 64f, 64g, and 64j from the first cascade, form a five-card flush that is one of the winning hands included within the paytable 68. Thus, this third set of winning cards 64f, 64g, 64j, 64k, and 64l is moved to the winning-hands area 98 (not shown) and the award values for both the first set of winning cards 64h,64e and the second set of winning cards 64i, 64e are awarded yet again. Another cascade of cards (in this case, five additional cards) will occur and, if a winning hand is formed, the above-described procedure is repeated.

The cascade bonus event terminates once a cascade does not result in a winning hand being created. At this point, the earned awards from both the standard draw-poker game and the cascade bonus event are distributed to the player or the player's account. Alternatively, or additionally, the cascade bonus event may terminate when there are no additional cards to be dealt from the 52-card deck.

According to another embodiment, when a second set of winning cards is achieved, an integral multiplier is awarded for the first set of winning cards that increases the award value contained in the paytable 68. The integral multiplier is utilized in place of re-awarding the award values contained in the paytable 68. For example, when a second set of winning cards is achieved, the award value for the first set of winning cards may receive a 2× multiplier. If a third set of winning cards is then received, the multiplier for the first set of winning cards may be increased to a 4× multiplier and a award value for the second set of winning cards my receive a 2× multiplier. According to other embodiments, the award value contained in the paytable 68 is increased by an integral multiplier for the second set of winning cards, as opposed to the first set of winning cards.

According to yet other embodiments of the present invention, a player earns an award once a predetermined number of cascades has been achieved. For example, the player may earn an award of 1000 credits when 5 winning cascade hands are achieved in a row. Alternatively, or additionally, a standard award can be provided for a cascade hand such that, for example, a pair-of-jacks cascade hand pays the same as a full-house cascade hand. This standard award value may then remain the same, increase, or decrease for each additional winning cascade hand that is formed by a player.

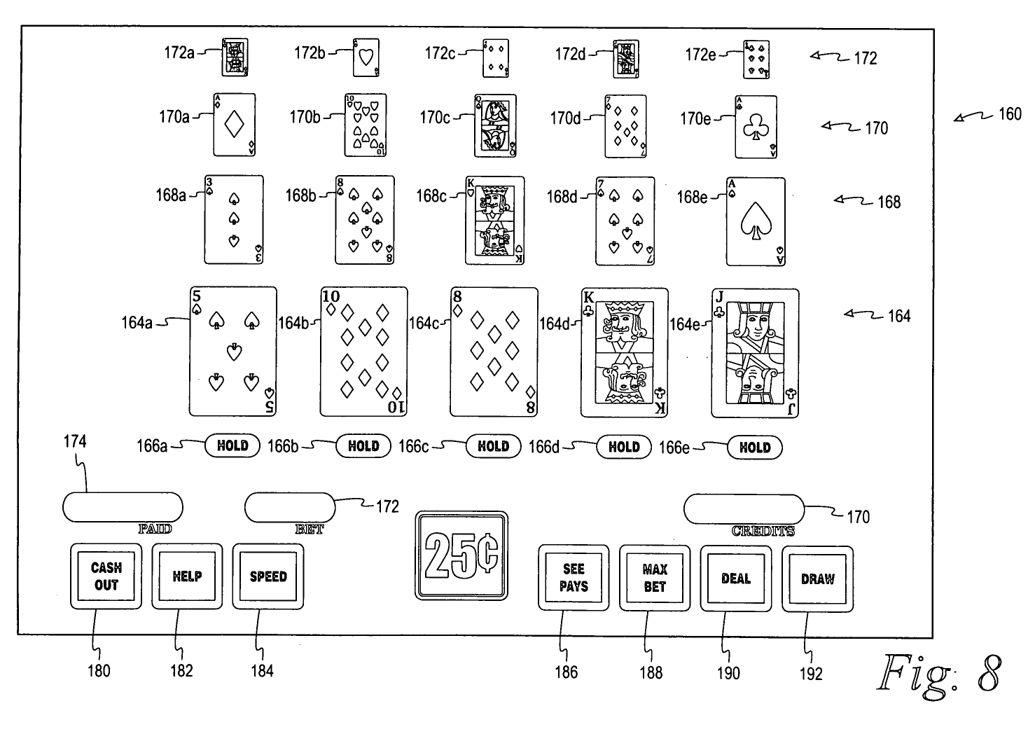

Turning now to FIG. 8, a main video-poker game screen 160 for presenting a poker game with a cascading bonus event is illustrated, according to another embodiment of the present invention. The main video-poker game screen 160 includes a first user-playable hand 164 that includes a plurality of cards 164a-e. A first cascading row 168 is located adjacent to the first user-playable hand 164. The first cascading row 168 includes a first plurality of cards 168a-e that are adapted to replace the cards removed from a final user-playable hand after the winning cards are removed. A second cascading row 170 formed by a second plurality of cards 170a-e and a third cascading row 172 formed by a third plurality of cards 172a-e are located adjacent to each other. The second cascading row 170 is located adjacent to the first cascading row 168, opposite the user-playable hand. The second and third pluralities of cards 170a-e and 172a-e are adapted to replace the cards that have cascaded from the first cascading row 168 and the second cascading row 170, respectively.

As described above with respect to FIGS. 3-4, a player decides which of the plurality of cards 164a-e to hold and can then hold the desired cards by selecting a corresponding hold button 166a-e. The non-held cards are then replaced to form a final user-playable hand. If a winning hand is formed, an award is paid for the winning hand and the winning cards are removed from the final user-playable hand and a cascade bonus event begins.

During the cascade bonus event, each of the removed winning cards is replaced by one of the first plurality of cards 168a-e that is located directly above (as illustrated in FIG. 8) the removed card. Each of the cards that has been removed from the first cascading row 168 is then replaced with one of the second plurality of cards 170a-e that is located directly above the removed card. Similarly, each of the cards in the second cascading row 170 that is used to replace a removed card from the first cascading row 170 is replaced with cards from the third cascading row 172. By replacing the removed winning cards with the cascade, a first cascade hand is formed, as detailed above with respect to FIG. 6. If the first cascade hand forms a winning hand, an award is paid, the winning cards are removed, and the cascade forms a second cascade hand. The cascade event continues until the cascade does not result in a winning hand being formed.

The cards from the first cascading row 168 used to replace the cards from the final user-playable hand (or any subsequent cascade hand) are defined as “replacement cards” and are used to form a cascade hand. The cards from the second cascading row 170 used to replace the replacement cards from the first cascading row 168 are defined as “secondary replacement cards.” The cards from the third cascading row 172 used to replace the secondary replacement cards from the second cascading row 170 are defined as “tertiary replacement cards.”

It should be noted that although the embodiment described in FIG. 8 has been illustrated with respect to a three-row cascading bonus event, any number of rows may be used for the cascading feature. According to one embodiment of the present invention, when one or more of the third plurality of cards 172a-e is removed to replace a card from the second cascading row 170, the tertiary replacement card is replaced by a card remaining in the deck. According to other embodiments, a tertiary replacement card is not replaced once it is moved from the third cascading row 172. In these embodiments, a removed card is only replaced by a card located in the cascading row above the removed card. In one of these embodiments, a bonus award is earned each time a cascading row is completely cleared (i.e., the cascade results in no cards occupying a particular cascading row).

By visually displaying the cascading rows to the player prior to the cascade, the excitement to a player can be increased. For example, where the player interprets the cascading rows as containing a number of good cards, the player may become excited about the possibility of a cascade that will bring those cards into play. Thus, according to one embodiment, the third cascading row 172 contains five cards that form a royal flush. The player may then attempt to cascade those five cards into play so as to achieve a royal-flush payout. In one embodiment, the cards from the royal flush remain in the subsequent cascade hands until the royal flush is achieved or until a winning hand is not formed. According to another embodiment, the cascading rows are not displayed to the player prior to the cascade so as not to influence the player's hold strategy.

Similarly, according to one embodiment of the present invention, wild cards can be displayed within the plurality of cascading rows. The wild cards can be used to form winning cascade hands. In some embodiments, the wild cards remain in the subsequent cascade hands until the royal flush is achieved or until a winning hand is not formed. According to one embodiment of the present invention, the player may be able to obtain more wild cards within the cascading rows by increasing their wager.

According to yet another embodiment of the present invention, a player is able to choose between winning hands formed in the final user-playable hand. For example, if the final user-playable hand forms a two-pair winning hand (e.g., a pair of jacks and a pair of kings) the player may choose to take only a winning single pair hand (e.g., just the pair of jacks). In this embodiment, the player can utilize the cascading rows to attempt to increase their winnings. In the above example, the player may select only the pair of jacks as the winning hand because, for example, the player sees a king directly above one or both of the jacks. Thus, the player will receive the award for the single pair of jacks and after the cascade can receive an additional award for the set (3) of kings or four of a kind.

According to still another embodiment, the cascading rows form an unrevealed array of cards. In this embodiment, once the winning cards are removed, the player selects the required number of cards from the array to replace the removed winning cards. In some embodiments, if the replacement cards form yet another winning hand, some of the cards in the array may be revealed to the player and the player may select from either or both of the revealed cards and the unrevealed cards to replace the winning cards. In these embodiments, as winning hands continue to be formed more cards from the array are revealed. Thus, the player's ability to form additional winning hands can increase as additional cards continue to be revealed.

Each of these embodiments and obvious variations thereof is contemplated as falling within the spirit and scope of the claimed invention, which is set forth in the following claims.

What is claimed is:

1. A method of conducting a wagering game on a gaming machine, the method comprising:
receiving a wager from a player to play the game;
displaying a plurality of cards from a deck of cards to form a user-playable hand;
selecting, via player selection, one or more of the plurality of cards to discard;
replacing each of the discarded cards with another card to form a final user-playable hand; and
initiating a cascade event in response to the final user-playable hand resulting in a winning hand being formed, the cascade event including
(i) removing winning cards from the winning hand of the final user-playable hand, and
(ii) replacing the removed winning cards with other cards to form a first cascade hand.

2. The method of claim 1, wherein the cascade event forms at least one additional cascade hand when the first cascade hand results in another winning hand being formed.

3. The method of claim 2, wherein the cascade event ends when the first cascade hand or one of the at least one additional cascade hand does not result in a winning hand being formed.

4. The method of claim 1 further comprising the act of providing a plurality of cascading rows adjacent to the user-playable hand, each of the plurality of cascading rows including a plurality of cards.

5. The method of claim 4, wherein the plurality of cascading rows includes a first cascading row and a second cascading row, the first cascading row being located adjacent to the user-playable hand, the second cascading row being located adjacent to the first cascading row opposite the user-playable hand.

6. The method of claim 5, wherein the plurality of cards in the first cascading row is used to replace the removed plurality of winning cards from the final user-playable hand, the cards used to replace the removed plurality of winning cards being replacement cards.

7. The method of claim 6, wherein the plurality of cards in the second cascading row is used to replace the replacement cards from the first cascading row, the cards used to replace the replacement cards being secondary replacement cards.

8. The method of claim 7 further including a third cascading row being located adjacent to the second cascading row and opposite the first cascading row, wherein the plurality of cards in the third cascading row is used to replace the secondary replacement cards from the second cascading row, the cards used to replace the secondary replacement cards being tertiary replacement cards.

9. The method of claim 8, wherein each of the tertiary replacement cards are replaced in the third cascading row by a card from the deck of cards.

10. The method of claim 4, wherein an award is provided for clearing one or more of the plurality of cascading rows.

11. The method of claim 4, wherein the plurality of cascading rows include one or more bonus cards.

12. A computer readable storage medium encoded with instructions for directing a gaming device to perform the method of claim 1.

13. A gaming machine for playing a wagering game comprising:
at least one display for displaying a plurality of randomly selected cards distributed from a deck of cards, the plurality of cards forming a user-playable hand, one or more of the cards in the user-playable hand being selectable by a player to be held, each of the non-selected cards being replaceable by a card from the deck of cards, the held cards and the replacement cards forming a final user-playable hand that indicates an outcome from a plurality of outcomes, at least one of the plurality of outcomes being a cascade-event-triggering outcome, the at least one display for displaying a cascade event in response to the outcome being the cascade-event-triggering outcome, the cascade event resulting in at least one cascade hand being formed subsequent to the final user-playable hand;
an input device for receiving selections from the player as to which of the plurality of cards in the user-playable hand should be held; and
a controller coupled to the display and the input device, the controller operative to
conduct the wagering game and the cascade event in response to receiving inputs from the input device, and
provide an award to the player based on the outcome of the wagering game and the cascade event.

14. The gaming terminal of claim 13, wherein the controller is located within the gaming terminal.

15. The gaming terminal of claim 13, wherein the cascade event forms at least one additional cascade hand when the at least one cascade hand results in a winning hand being formed.

16. The method of claim 14, the at least one display for displaying a plurality of cascading rows adjacent the user-playable hand, each of the plurality of cascading rows including a plurality of cards from the deck of cards.

17. A method of conducting a video poker game, the video poker game including a plurality of winning hands that award corresponding payouts to a player, the method comprising:
receiving a wager from a player to play the video poker game;
in response to receiving the wager, forming a final user-playable hand including a plurality of cards that are displayed to the player on a display;
in response to the final user-playable hand being one of the plurality of winning hands, removing the cards forming a winning combination within the winning hand from the final user-playable hand and replacing the removed cards with other cards to form a first bonus hand; and
awarding a first payout corresponding to the one of the plurality of winning hands in the final user-playable hand.

18. The method of claim 17 further comprising in response to the first bonus hand being one of the plurality of winning hands, removing the cards forming a winning combination within the winning hand from the first bonus hand and replacing the removed cards with other cards to form a second bonus hand.

19. The method of claim 17 further comprising awarding a second payout corresponding to one of the plurality of winning hands in the first bonus hand.

20. The method of claim 19, wherein the first payout is awarded again in response to the second payout being awarded.

21. The method of claim 19, wherein the first payout is increased in response to a second payout being awarded.

22. The method of claim 17 further comprising displaying a plurality of other cards to create a cascade effect for replacing the removed cards from the final user-playable hand.
